(19) United States
(12) Patent Application Publication
(10) Pub. No.: US 2006/0247808 A1
(43) Pub. Date: Nov. 2, 2006

(54) Computer-implemented method, tool, and program product for training and evaluating football players

(76) Inventor: Walter L. Robb, Schenectady, NY (US)

Correspondence Address: HOFFMAN WARNICK & D'ALESSANDRO, LLC, 75 STATE STREET, 14TH FLOOR, ALBANY, NY, 12207, US

(21) Appl. No.: 11/404,942

(22) Filed: Apr. 14, 2006

Related U.S. Application Data
(60) Provisional application No. 60/671,722, filed on Apr. 15, 2005.

(51) Int. Cl. G06F 19/00

(52) U.S. Cl. 700/91

(57) ABSTRACT

A computer-implemented method, system, and program product for training and/or evaluating a member of a football team with regard to the actions that are required for his or her position on the field is provided. Specifically, under the present invention, a member of a football team, referred to as a user, may select a position from a list of positions on a football team. The user is provided with a playbook that indicates the actions that the user is to take for each play in the playbook. After, while, or without accessing the playbook, execution of a computerized football game is started; a play from the playbook is selected; and the selected play is executed by the game. Before and/or during the execution of the play, the user provides one or more inputs to the game that correspond to the action(s) the user believes are required of him/her based on the selected play. The input(s) are used by the game to provide feedback that indicates how well the required actions were performed by the user.

### REFERENCE TO PRIOR APPLICATION

The current application claims the benefit of co-pending U.S. Provisional Application No. 60/671,722, entitled “Football Game”, which was filed on Apr. 15, 2005, and which is hereby incorporated herein by reference.

### FIELD OF THE INVENTION

The present invention generally relates to automated instruction. Specifically, the present invention provides a solution that, for a particular group of plays, automatically instructs a user to perform the physical tasks required of a football player that plays a specific position.

### BACKGROUND OF THE INVENTION

The game of football is a physically and mentally challenging game. One of the primary challenges to the success of a football team is the requirement that each of the members of the team knows and performs his or her required assignment for any given play. For a player on offence, this assignment may include knowing where to begin the play, whether or not to go in motion before the play starts, how to adjust to the defensive alignment, when the play is to start, and what duties to perform once the play has started. Similarly, a player on defense needs to know where to begin the play, how to adjust to the offensive alignment, how to anticipate the probable offensive play calls based on the game time situation, how to react quickly to the beginning of the play, and what duties to perform once the play has started. Thus, each member of the team must be constantly aware of his duties in order to provide the greatest opportunity for team success.

One challenge for training the members of a football team lies in the sheer number of duties that must be taught. As shown above, each of the members of the team may have several different assignments for a particular play. Additionally, a player may be required to learn the duties that are required for upwards of one hundred different plays. As such, football coaches must spend significant time with each player in order to teach him/her the required tasks. The time that is spent with players often takes the form of classroom time, in which the mental aspects of the game are learned, and practice time, in which the mental aspects are applied in physical execution of the plays.

Several shortcomings exist in the current techniques for teaching football to members of the team. First, because there are usually far fewer coaches than players, both the classroom and practice time are usually conducted in groups. This limits the one-on-one time between player and coach and can slow the learning process. To remedy this, players are often given lists of plays that show each player's responsibilities for each play. However, these lists do not necessarily show situational factors, such as what should be done to adjust to a particular game time situation. In addition, such a list of plays may be tedious for a member of a team to memorize and, as such, retention may suffer. Still further, the list of plays teaching approach does not provide any mechanism for determining whether a particular player grasps the concepts that are being taught. Instead, the coach must wait until practice time to determine whether team members are performing the correct tasks, and with the correct timing for a particular play or series of plays. This is not optimal because practice time is often limited due to factors such as weather, light and availability of practice facilities. In addition, as with the classroom environment, each coach's time during the practice must be divided among the many team members that must be evaluated simultaneously. As such, a deficiency in a particular player's understanding of a concept and/or responsibility may remain hidden for a long time.

In view of the foregoing there exists a need for a solution that overcomes the above-referenced deficiencies.

### SUMMARY OF THE INVENTION

In general, the present invention provides a computer-implemented method, system, and program product for training and/or evaluating a member of a football team with regard to the actions that are required for his or her position on the field. Specifically, under the present invention, a member of a football team, referred to as a user, may select a position from a list of positions on a football team. The user is provided with a playbook that indicates the actions that the user is to take for each play in the playbook. After, while, or without accessing the playbook, execution of a computerized football game is started; a play from the playbook is selected; and the selected play is executed by the game. Before and/or during the execution of the play the user provides one or more inputs to the game that correspond to the action(s) the user believes are required of him/her based on the selected play. The input(s) are used by the game to provide feedback that indicates how well the required actions were performed by the user.

The training that is provided by this invention has several advantages over the current ways of teaching. First of all, the training of the present invention is interactive. This allows the user to immediately apply the lessons learned and, thus, to reinforce these lessons in the user's memory. The interactive game nature of the present invention also helps to keep the user engaged and thus can prevent boredom. Furthermore, multiple users can play, and thus be trained and/or evaluated simultaneously, either separately or in conjunction with other teammates. This simultaneous training, evaluation and/or feedback in effect provides a one-on-one coaching experience for every player. In addition, the training of multiple players during a single game promotes a sense of camaraderie and competition while further honing each member's skills in conjunction with other members of the team. Still further, the feedback system allows a team member to receive feedback regarding how well he performed his required actions so that he will know in which areas improvement is needed. This feedback may be provided directly to the team member during and/or after the execution of the game, may be relayed to the coach, or both.

A first aspect of the present invention provides a system for evaluating a football player, comprising: a system for providing a plurality of football player types from which a football player type is selected, wherein each football player type in the plurality of football player types is a defined position of the football player; a football playbook that includes a plurality of football plays, wherein each of the plurality of football plays in the football playbook indicates at least one required football action to be performed by the selected football player type; a system for obtaining a selection of one of the plurality of football plays to be executed; a football play executor for executing the selected play; a football action receiver for receiving, as the selected play is executed, a performed football action; a football action evaluation system for evaluating whether the performed football action matches the required football action; and a football action feedback system for providing feedback based on the evaluation.

A second aspect of the present invention provides a method for evaluating a football player, comprising: providing a plurality of football player types from which a football player type is selected, wherein each football player type in the plurality of football player types is a defined position of a football player; providing a plurality of football plays, wherein each of the plurality of football plays indicates at least one required football action to be performed by the selected football player type; obtaining a selection of one of the plurality of football plays to be executed; executing the selected play; receiving, as the selected play is executed, a performed football action; evaluating whether the performed football action matches the required football action; and providing feedback based on the evaluation.

A third aspect of the present invention provides a program product stored on a computer readable medium for evaluating a football player, the computer readable medium comprising program code for causing a computer system to perform the following: provide a plurality of football player types from which a football player type is selected, wherein each football player type in the plurality of football player types is a defined position of a football player; provide a plurality of football plays, wherein each of the plurality of football plays indicates at least one required football action to be performed by the selected football player type; obtain a selection of one of the plurality of football plays to be executed; execute the selected play; receive, as the selected play is executed, a performed football action; evaluate whether the performed football action matches the required football action; and provide feedback based on the evaluation.

A fourth aspect of the present invention provides a method for deploying an application for evaluating a football player, comprising: providing a computer infrastructure being operable to: provide a plurality of football player types from which a football player type is selected, wherein each football player type in the plurality of football player types is a defined position of a football player; provide a plurality of football plays, wherein each of the plurality of football plays indicates at least one required football action to be performed by the selected football player type; obtain a selection of one of the plurality of football plays to be executed; execute the selected play; receive, as the selected play is executed, a performed football action; evaluate whether the performed football action matches the required football action; and provide feedback based on the evaluation.

A fifth aspect of the present invention provides computer software embodied in a propagated signal for evaluating a football player, the computer software comprising instructions for causing a computer system to perform the following steps: provide a plurality of football player types from which a football player type is selected, wherein each football player type in the plurality of football player types is a defined position of a football player; provide a plurality of football plays, wherein each of the plurality of football plays indicates at least one required football action to be performed by the selected football player type; obtain a selection of one of the plurality of football plays to be executed; execute the selected play; receive, as the selected play is executed, a performed football action; evaluate whether the performed football action matches the required football action; and provide feedback based on the evaluation.

Therefore, the present invention provides a computer-implemented method, system, and program product for training and/or evaluating a football player.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for evaluating a user's mental football skills according to the present invention.

FIG. 2 shows an illustrative drop down box for selecting a player type according to one embodiment of the invention.

FIG. 3 shows an illustrative diagram of a play according to one embodiment of the invention.

FIG. 4 shows another illustrative diagram of a play according one embodiment of the invention.

FIG. 5 shows an illustrative method flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### BEST MODE FOR CARRYING OUT THE INVENTION

As indicated above, the present invention provides a computer-implemented method, system, and program product for training and/or evaluating a member of a football team with regard to the actions that are required for his or her position on the field. Specifically, under the present invention, a member of a football team, referred to as a user, may select a position from a list of positions on a football team. The user is provided with a playbook that indicates the actions that the user is to take for each play in the playbook. After, while, and/or without accessing the playbook, execution of a computerized football game is started; a play from the playbook is selected; and the selected play is executed by the game. Before and/or during the execution of the play the user provides one or more inputs to the game that correspond to the action(s) the user believes are required of him based on the selected play. These input(s) are used by the game to provide feedback that indicates how well the required actions were performed by the user.

The training that is provided by this invention has several advantages over the current approaches to teaching football. First of all, the training of the present invention is interactive. This allows the user to immediately apply the lessons learned and, thus, to reinforce these lessons in the user's memory. The interactive game nature of the present invention also helps to keep the user engaged and thus to prevent boredom. Furthermore, multiple users can play, and thus be trained and/or evaluated simultaneously, either separately or in conjunction with other teammates. This simultaneous training, evaluation and/or feedback in effect provides a one-on-one coaching experience for every player. In addition, the training of multiple players during a single game promotes a sense of camaraderie and competition while further honing each member's skills in conjunction with other members of the team. Still further, the feedback system allows a team member to receive feedback regarding how well he performed his required actions so that he will know in which areas improvement is needed. This feedback may be provided directly to the team member during/or after the execution of the game, may be relayed to the coach, or both.

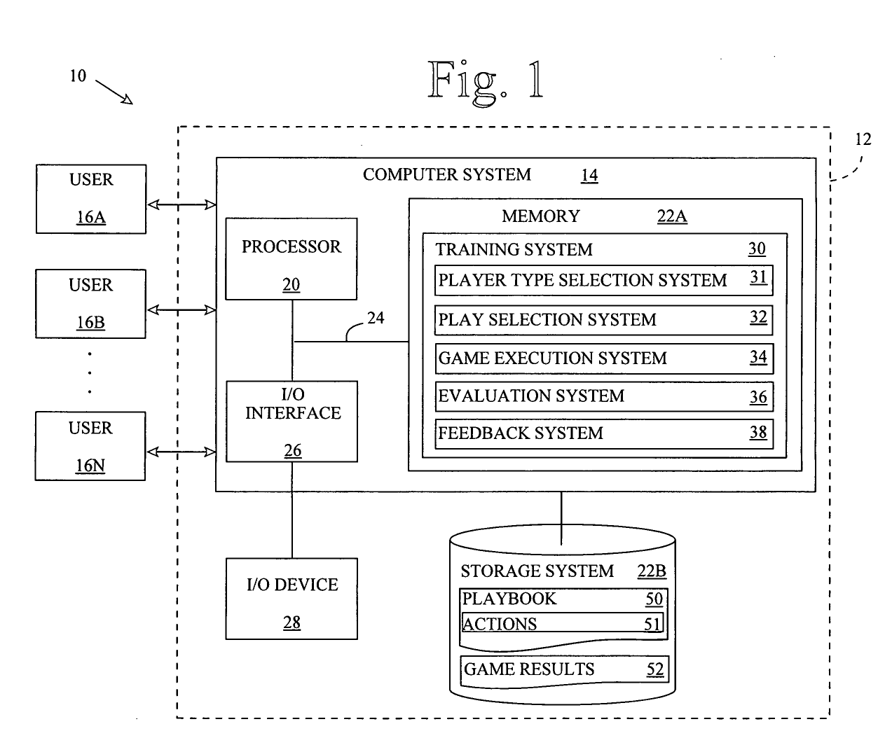

Referring now to FIG. 1, a system 10 for evaluating a user's mental football skills according to the present invention is shown. Specifically, FIG. 1 shows an illustrative system 10 for training users 16A-N about football. To this extent, system 10 includes a computer infrastructure 12 that can perform the process described herein for training one or more users 16A-N. As depicted, system 10 includes a computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 12 is intended to demonstrate that some or all of the components of system 10 could be deployed, managed, serviced, etc. by a service provider who offers to evaluate one or more users' mental football skills.

As shown, computer system 14 includes a processor 20, a memory 22A, a bus 24, and input/output (I/O) interface 26. Further, computer system 14 is shown in communication with external I/O device/resource 28 and storage system 22B. In general, processor 20 executes computer program code, such as training system 30, which may be stored in memory 22A and/or storage system 22B. While executing computer program code, processor 20 can read and/or write data to/from memory 22A, storage system 22B, and/or I/O interface 26. Bus 24 provides a communication link between each of the components in computer system 14. External device 28 can comprise any device (e.g., keyboard, pointing device, display, etc.) that enables a user to interact with computer system 14 and/or any device (e.g., network card, modem, etc.) that enables computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the process of the invention. Moreover, computer system 14 is only representative of various possible computer systems that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processor 20 may comprise a single processing unit, or be distributed across one or more processing units in one or more locations, e.g., on a client and server. Similarly, memory 22A and/or storage system 22B can comprise any combination of various types of data storage and/or transmission media that reside at one or more physical locations. Further, I/O interface 26 can comprise any system for exchanging information with one or more external devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 22B could be contained within computer system 14, not externally as shown.

Storage system 22B can be any type of system (e.g., a database) capable of providing storage for information under the present invention, such as a playbook 50 of plays, actions 51 that are required to be performed during plays, game results 52 including evaluations and feedback, etc. To this extent, storage system 22B could include one or more storage devices, such as a magnetic disk drive or an optical disk drive. In another embodiment, storage system 22B includes data distributed across, for example, a local area network (LAN), wide area network (WAN) or a storage area network (SAN) (not shown). Although not shown, additional components, such as cache memory, communication systems, system software, etc., may be incorporated into computer system 14.

As discussed herein, training system 30 enables computing infrastructure 12 to be used in training and/or evaluating one or more users 16A-N. To this extent, training system 30 is shown including a player type selection system 31, a play selection system 32, a game execution system 34, an evaluation system 36, and a feedback system 38. Operation of each of these systems is discussed further below. However, it is understood that some of the various systems shown in FIG. 1 can be implemented independently, combined, and/or stored in memory for one or more separate computing devices that are included in computer infrastructure 12. Further, it is understood that some of the systems and/or functionality may not be implemented, or additional systems and/or functionality may be included as part of system 10.

Player type selection system 31 provides a plurality of football player types from which a football player type is selected. Each football player type in the plurality of football player types is a defined position of a football player. Player type selection system 31 may allow user 16A that is being trained and/or evaluated to select the football player type, may allow an alternate user 16N, such as a coach, to select the player type, or may assign a player type for user 16A according to a known identity of 16A or any other factor. In one embodiment, training system 30 can obtain an identification of the player, and automatically assign and/or limit the possible positions based on the identification. For example, a database of users 16A-N and their corresponding position(s) can be maintained by training system 30.

The football player type that is selected using player type selection system 31 may be any position of a football team, including, but not limited to offensive players such as: quarterback, running back (such as halfback, fullback, and tailback), offensive lineman (such as offensive guard, offensive tackle, center, and tight end), receiver; defensive players such as: defensive lineman (such as defensive tackle, defensive end and nose tackle), linebacker (such as inside linebacker and outside linebacker), corner back, safety (such as strong safety and free safety); and special teams players such as: kicker, punter, holder, long snapper, gunner, etc. The football player type that is chosen using player type selection system 31 may indicate that the football player type is to be used by the selector for an entire game, a series of plays or a single play.

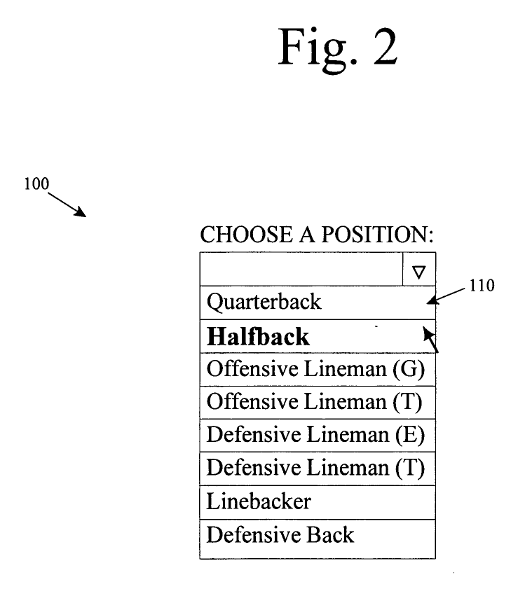

FIG. 2 shows selection of a football player type from a plurality of player types according to one embodiment of the claimed invention. In this embodiment, drop down box 100 indicates a selection of football player types 110 from which a selection may be made. In this example, a selection of halfback has been made.

Returning to FIG. 1, play selection system 32 allows selection of one or more football plays to be executed. To this extent, a playbook 50 is provided that includes a number of football plays from which the football play to be executed is selected. Each play in the playbook 50 indicates at least one required football action 51 to be performed by one or more of the football players including the football player of the football player type selected by player type selection system 31. Examples of possible football actions 51 that are included in playbook 50 may include a position on the field within a formation that the player type is to line up initially; an action, such as backfield motion, that a player type is to take prior to the beginning of the play; an adjustment that the player type is supposed to make based on a particular formation of the opposing team; and/or a direction in which the player is to move at the start of the play.

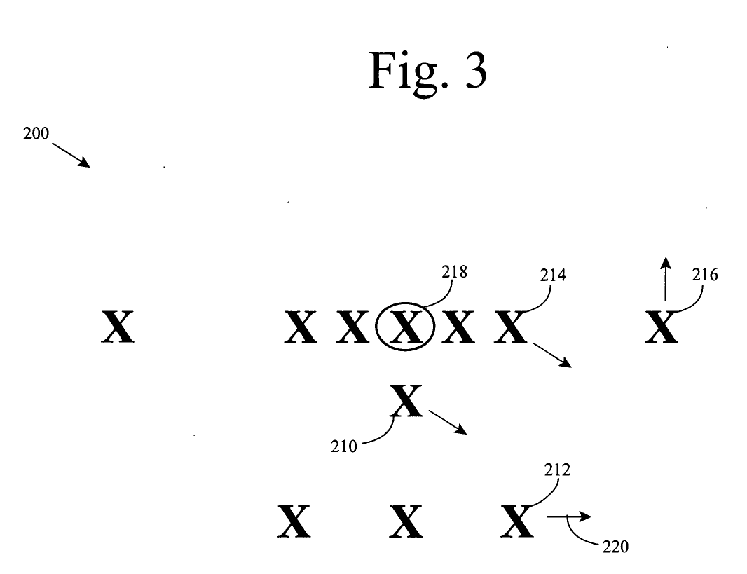

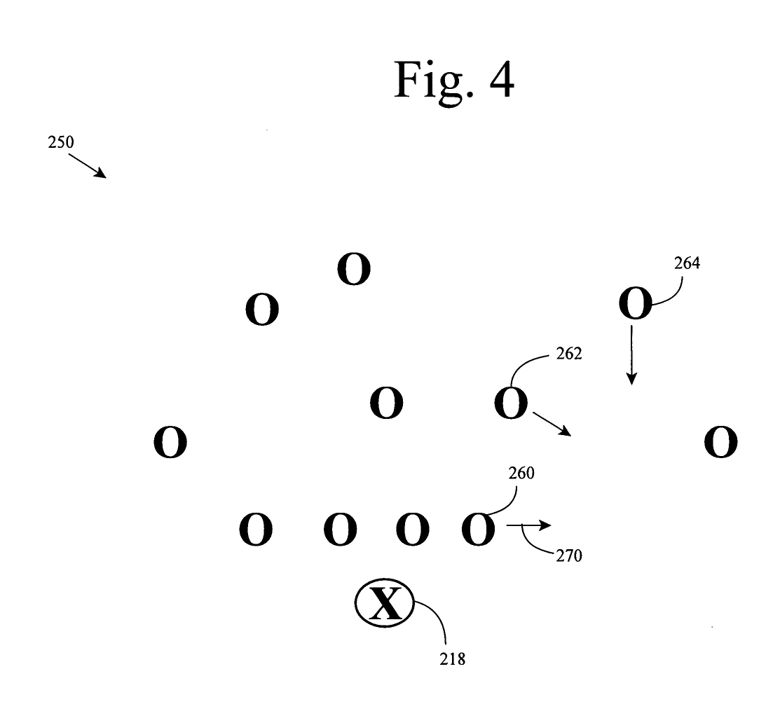

FIGS. 3 and 4 show examples of diagrams of possible plays 200, 250 in playbook 50 (FIG. 1) according to one embodiment of the invention. FIG. 3 shows a diagram 200 of an offensive play in playbook 50, which may be called “right end run”. Diagram 200 shows player types that represent a quarterback 210, a halfback 212, a guard 214, a receiver 216 and a center 218. Diagram 200 also shows actions, such as halfback action 220 that correspond to different player types. For example, in diagram 200, action 220 corresponding to halfback 212 is to move to the right upon the beginning of the play.

Similarly, FIG. 4 shows a diagram 250 that may correspond to a defensive play in playbook 50, which may be called “stop right end run”. As in FIG. 3, center 218 may be displayed to demonstrate a defensive alignment. Furthermore, player types of a defensive end 260, a linebacker 262 and a defensive back 264 are displayed. As in FIG. 3, actions, such as defensive end action 270 may indicate a required task for the particular player type before and/or when the play is executed. In this example, defensive end 260 is required to perform action 270 and move left (right on the screen) upon commencement of the play.

Returning to FIG. 1, playbook 50 may be provided in many different ways. In one embodiment, a user 16N that is using training system 30 to train and/or evaluate another user 16A may select one or a series of plays from playbook 50. In another alternative, one of the users 16A-16N being evaluated may be allowed to select the plays from playbook 50. In this embodiment, one or more plays in playbook 50, such as diagrams 200, 250 of FIGS. 3 and 4, may be displayed by system 10 during selection of a play with play selection system 32. Alternatively, a list of names or designations of plays in playbook 50 may be displayed, without displaying diagrams 200, 250, from which a user 16A that is being trained and/or evaluated may choose. In yet another embodiment, play selection system 32 may require user 16A to input a name or designation that corresponds to the play being entered. Still further, one or more plays in playbook 50 may be printed to enable users 16A-16N to review the playbook when away from a computer.

To this extent, system 10 can increase the level of difficulty based on the evaluation of a user. For example, for a new user, a play may be called and the corresponding diagram for the play can be displayed. However, as the user becomes more skilled, less information can be given. To this extent, for a highly skilled user, the user may not be able to view the plays and may be required to select the plays based on the game situation. In this manner, the player's ability to remember plays, understand game situations, and/or call plays can be evaluated. Training system 30 may also include a playbook modification system that allows a coach or other person to customize playbook 50 (e.g., plays, play names, alternative names for audible calls, etc.) to reflect the particular plays and actions 51 that are peculiar to a particular team.

In any case, play selection system 32 may allow a user 16A whose player type is an offensive player type to choose an offensive play from playbook 50. Similarly, play selection system 32 may allow a user 16B whose player type is a defensive player type to select a defensive play that he believes will counteract the play that is selected by the offensive player or computer. When two or more players are playing on offense or defense, one player can be designated as the player to call the play from playbook 50.

Additionally, depending on a selected position, play selection system 32 can allow selection of a snap count for the play. For example, any offensive player can select the snap count, a quarterback can select the snap count, and/or the like. The snap count indicates, for example, a number of times the word “Hutt” is displayed and/or audibly generated prior to the start of the play. In the latter case, a recording of the quarterback can be used to provide a more realistic experience and enable the other players to become familiar with the individual's cadence. Regardless, each offensive player is given the snap count prior to the start of the play. The offensive player must react quickly to the correct snap count. In this manner, each offensive player's ability to remember the snap count can be evaluated.

Game execution system 34 executes the play that is selected using play selection system 32. Game execution system 34 may allow a single user 16A to play against game execution system 34. In the alternative, multiple users 16A-16N may be permitted to play simultaneously. In the multiple user embodiment, one or more users 16A-16N may play in cooperation against game execution system 34 or may play against one or more users 16A-16N. To this extent, two or more computers may be connected such that each player has his own computer, or a single computer may have a divided keyboard, with an optical shield between the halves so that two players may be at one computer, but neither can see the other player's side of the keyboard. Alternatively, a single user, such as user 16B, can play the game against an automated opponent implemented by game execution system 34. In either case, game execution system 34 can generate a display of a football field and the results on one or more computer monitors used by users 16A-N. Further, game execution system 34 can store game results 52 for each selected play during a particular game for later reference and/or evaluation. The game results 52 can be generated and stored in any known manner, e.g., as one or more records in a database.

As game execution system 34 is executing the game, a football action receiver may receive an indicated football action to be performed by the selected player type that corresponds to the selected play. This football action may be received using a keyboard, a joystick a mouse or any other I/O device 28 now known or later developed. The received football action may indicate, for example, a location on the field of the player type, a direction of movement of the player type, and/or a change of the selected play.

For example, turning again to FIG. 3, the computer may give a long beep, followed by a short beep with timing similar to what a Quarterback might call “Ready, Hutt, Hutt, Hutt”, etc. Alternatively, a synthesized voice or the like can be used to generate a more realistic snap count. In any event, the offensive player must remember the selected play, the number of the snap, and action 51 must be performed upon the snap. In the case of halfback 212, the user 16A must remember to indicate an action 51 that corresponds to halfback action 220. In one embodiment, there are four keys for direction of motion, and the player must be prepared to press the correct key as soon as the “Hutt” for the snap is sounded. If user 16A presses the correct key too soon, a penalty may be assessed for “offsides” or “illegal motion.” Similarly, if user 16A presses an incorrect key or presses the correct key after too much time has elapsed following the sounding of the “Hutt” for the snap, a yardage penalty may be assessed on the play. As, such, the result of the play will partly depend on how quickly he/she presses the correct motion key at the correct “Hutt”. Thus, when a player is on offense, he/she must remember, among other things, what play was called, an initial action for that play, and the signal for the center to initiate the play.

Similarly, referring to FIG. 4, a player having a player type that is defensive must also remember required actions 51 as indicated by playbook 50, such as an initial move upon snap of the ball. For example, defensive end 260 is required to make an indication of an action 51 that corresponds to defensive end action 270 upon snap of the ball. However, the defensive player does not know the signal for the snap of the ball, and his/her timing must be based on watching the computer monitor and noting when the center hands the ball to the quarterback. Thus he/she learns to call reasonable defensive alignments, must remember the initial action for the position he/she is playing, and must learn to respond quickly to the center's action.

In general, the normal rules of football apply to the simulated football game. The yards gained or lost as a result of each play are determined by the rules. In addition, game execution system 36 may allow users 16A-N to execute the entirety of a play or, in the alternative, users 16A-N may be allowed to perform only an initial move corresponding to action 51 in playbook 50 and a look up table may be consulted to determine the results of the play in light of the actions received. In particular, the look up table can comprise a set of results for each combination of offensive and defensive play calls. The set of results can reflect typical results for the offensive and defensive play calls. For example, when the play calls are the same, the defense will generally have success in defending the play, and therefore the resulting yards for the offense will be lower. Game execution system 36 can generate a random number, which is used to select one of the set of results to add randomness.

Further, game execution system 36 can adjust the selected result based on the actions of the player(s) on initiation of the play. For example, a player can be rewarded (e.g., additional yards for offense) for the timeliness of his/her keystroke on the right count on offense or on initiation of the play on defense, on moving in a correct direction, and/or the like. Similarly, a player can be punished (e.g., fewer yards for offense) for a slow response to the start of the play, moving in an incorrect direction, and/or the like. In summary, players are rewarded for choosing appropriate plays, and acting appropriately quickly and correctly. The game can continue for a certain number of plays (e.g., four quarters each with twenty plays). For example, the game could comprise four quarters, during which a predetermined total number of plays can be selected. The number of plays could be based on the number of plays typically played during an average quarter of a football game and/or be selected by a user 16A-N. Alternatively, the game can continue as long as the player like, until one player scores a certain amount of points, or the like. Regardless, the game proceeds like a real football game, with the offensive player selecting plays and the defensive player trying to anticipate those plays. As such, both training and entertainment are provided.

As previously noted, evaluation system 36 of training system 30 can generate game results 52. Game results 52 provided by evaluation system 36 can indicate whether user 16A-N performed one or more actions 51 correctly according to playbook 50. In addition, game results 52 provided by evaluation system 36 may grade the performance of a user 16A, including a breakdown of the areas that were performed well and those that require more training. Game results 52 can comprise a compilation of all plays performed by user 16A-N, a set number of the most recent plays, and/or the like. Further, evaluation system 36 can categorize game results 52 based on each user 16A-N, each play in playbook 50, each position of player, and/or the like. This flexibility can enable a coach to evaluate a level of understanding of certain positions, plays, and/or players, which can enable the coach to configure a practice accordingly.

Feedback system 38 provides game results 52 generated by evaluation system 36. Feedback system 38 may provide game results 52 directly to users 16A-16N after the completion of a particular play. To this extent, feedback system 38 may provide only a statement of actions 51 that were performed correctly by user 16A and those that were performed incorrectly. In addition, feedback system 38 may include some action that affects the game being executed by game execution system 34. This action may include an addition or subtraction of yards as a result of a good or poor execution of actions 51 or a penalty that reflects that action 51 was performed incorrectly or at the incorrect time, for example if an offensive player began moving prior to the snap of the ball.

Subsequently, or in the alternative, feedback system 38 can provide an alternate user 16N, such as a coach with game results 52 generated by evaluation system 36. Based on the evaluation, user 16N can use feedback system 38 to provide feedback to user 16A. For example, user 16N can identify one or more areas in which user 16A requires improvement, complement user 16A on excelling in one or more areas, and/or the like. Further, user 16N can incorporate his/her knowledge to adjust emphasis on one or more elements of the game during a practice.

Further, feedback system 38 can be used to gradually increase what is expected of user 16A while playing the game. For example, as user 16A becomes better at correctly reacting to actions 51 required by football player type, play selection system 32 may be modified to hide diagrams 200, 250 of plays 50 from user 16A so that he/she is forced to remember his/her actions 51 based on the name of the play. Further, when user 16A is not the quarterback, game execution system 34 can automatically generate an audible that uses an alternative play identification. Various additional features can be implemented as will be recognized by one in the art.

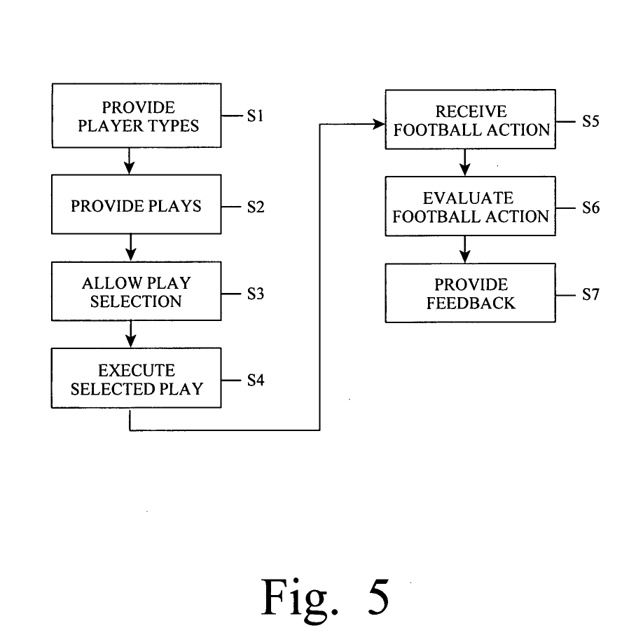

Turning now to FIG. 5, a flow chart of a method according to one embodiment of the present invention is depicted. FIG. 5 will be described with reference to FIG. 1. In first step S1, player selection system 31 provides a plurality of football player types from which a football player type is selected. Each football player type in the plurality of football player types provided by player selection system 31 is a defined position of a football player on a football team. In step S2, a plurality of football plays is provided, such as in playbook 50. Each of the plurality of football plays in playbook 50 indicates at least one required football action 51 that is to be performed by the selected football player type, for example, halfback action 220 of FIG. 3. In step S3, play selection system 31 allows selection of one or more of the football plays in playbook 50 in order to be executed.

In step S4, game execution system 34 executes the selected play. In step S5, an indication of the football action that is required by playbook 50 is received by user 16A as the selected play is executed. In step S5, evaluation system 36 evaluates the received football action to determine whether it matches the football action 51 required by playbook 50. Finally, in step S6, feedback system 38 provides feedback based on the evaluation performed by evaluation system 36.

While discussed primarily in the context of evaluating and training players on a football team, it is understood that the invention is not limited to only this application. For example, the invention can be used apart from any organized team, e.g., among a group of friends, who can compete and evaluate one another's relative football skills. Further, it is understood that the invention can be configured for any variation of football, including fewer than eleven players on the field, and can be used to assist in evaluating users of any age/skill level. Still further, it is understood that the teachings of the invention can be applied to other sports and contests that require a high degree of teamwork, mental preparation, reaction to a particular event, pre-selected plays, and/or the like.

While shown and described herein as a method and system for training an individual about football, it is understood that the invention further provides various alternative embodiments. For example, in one embodiment, the invention provides a computer-readable medium that includes computer program code to enable a computer infrastructure to train an individual about football. To this extent, the computer-readable medium includes program code, such as training system 30 (FIG. 1), that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22A (FIG. 1) and/or storage system 22B (FIG. 1) (e.g., a fixed disk, a read-only memory, a random access memory, a cache memory, etc.), and/or as a data signal traveling over a network (e.g., during a wired/wireless electronic distribution of the program code). Alternatively, the invention can be embodied as a combination of the embodiments illustrated herein. In particular, the invention can provide a board game that includes one or more computing devices that assist in playing the game.

In another embodiment, the invention provides a business method that performs the process steps of the invention on a subscription, advertising, and/or fee basis. That is, a service provider, such as an Internet Service Provider, could offer to train an individual about football as described above. In this case, the service provider can create, maintain, support, etc., a computer infrastructure, such as computer infrastructure 12 (FIG. 1), that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for training an individual about football. In this case, a computer infrastructure, such as computer infrastructure 12 (FIG. 1), can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computing device, such as computing device 14 (FIG. 1), from a computer-readable medium; (2) adding one or more computing devices to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A system for evaluating a football player, comprising:
a system for providing a plurality of football player types from which a football player type is selected, wherein each football player type in the plurality of football player types is a defined position of the football player;
a football playbook that includes a plurality of football plays, wherein each of the plurality of football plays in the football playbook indicates at least one required football action to be performed by the selected football player type;
a system for obtaining a selection of one of the plurality of football plays to be executed;
a football play executor for executing the selected play;
a football action receiver for receiving, as the selected play is executed, a performed football action;
a football action evaluation system for evaluating whether the performed football action matches the required football action; and
a football action feedback system for providing feedback based on the evaluation.

2. The system of claim 1, wherein the plurality of football player types includes lineman, running back, linebacker and defensive back.

3. The system of claim 1, wherein the at least one required football action includes indicating a direction within a time period following a snap of a football.

4. The system of claim 1, wherein the football play executer allows a first trainee to execute the selected football play in opposition to a second trainee.

5. The system of claim 1, wherein the football play executer allows a first trainee to execute the selected football play in conjunction with a second trainee.

6. The system of claim 1, further comprising a football coach evaluation system for allowing a coach to evaluate each football player who has accessed the system.

7. The system of claim 1, wherein the system for obtaining the selection of the one of the plurality of football plays obtains a selection of a snap count, wherein the required football action includes an indication of a direction for the football player type and wherein the football action evaluation system evaluates whether the football action is performed within a predetermined time after a completion of the snap count.

8. A method for evaluating a football player, comprising:
providing a plurality of football player types from which a football player type is selected, wherein each football player type in the plurality of football player types is a defined position of a football player;
providing a plurality of football plays, wherein each of the plurality of football plays indicates at least one required football action to be performed by the selected football player type;
obtaining a selection of one of the plurality of football plays to be executed;
executing the selected play;
receiving, as the selected play is executed, a performed football action;
evaluating whether the performed football action matches the required football action; and
providing feedback based on the evaluation.

9. The method of claim 8, wherein the plurality of football player types includes lineman, running back, linebacker and defensive back.

10. The method of claim 8, wherein the at least one required football action includes indicating a direction within a time period following a snap of a football.

11. The method of claim 8, wherein obtaining the selection of the one of the plurality of football plays obtains a selection of a snap count, wherein the required football action includes an indication of a direction for the football player type and wherein the football action evaluation system evaluates whether the football action is performed within a predetermined time after a completion of the snap count.

12. The method of claim 8, further comprising evaluating a level of skill of at least one player who has an evaluation for a set of plays.

13. A program product stored on a computer readable medium for evaluating a football player, the computer readable medium comprising program code for causing a computer system to perform the following:
provide a plurality of football player types from which a football player type is selected, wherein each football player type in the plurality of football player types is a defined position of a football player;
provide a plurality of football plays, wherein each of the plurality of football plays indicates at least one required football action to be performed by the selected football player type;
obtain a selection of one of the plurality of football plays to be executed;
execute the selected play;
receive, as the selected play is executed, a performed football action;
evaluate whether the performed football action matches the required football action; and
provide feedback based on the evaluation.

14. The program product of claim 13, wherein the plurality of football player types includes lineman, running back, linebacker and defensive back.

15. The program product of claim 13, wherein the at least one required football action includes indicating a direction within a time period following a snap of a football.

16. The system of claim 13, wherein the system for obtaining the selection of the one of the plurality of football plays obtains a selection of a snap count, wherein the required football action includes an indication of a direction for the football player type and wherein the football action evaluation system evaluates whether the football action is performed within a predetermined time after a completion of the snap count.

17. The program product of claim 13, further comprising program code for causing a computer system to allow a coach to evaluate each player who has accessed the system.
